(19) United States
(12) Patent Application Publication
(10) Pub. No.: US 2006/0264204 A1
(43) Pub. Date: Nov. 23, 2006

(54) Method for sending a message waiting indication

(75) Inventor: Jason D. Livingood, Philadelphia, PA (US)

Correspondence Address: BROOKS KUSHMAN P.C., 1000 TOWN CENTER, TWENTY-SECOND FLOOR, SOUTHFIELD, MI, 48075, US

(73) Assignee: COMCAST CABLE HOLDINGS, LLC, Philadelphia, PA (US)

(21) Appl. No.: 11/132,586

(22) Filed: May 19, 2005

(51) Int. Cl. H04M 1/00

(52) U.S. Cl. 455/412.2; 455/418

(57) ABSTRACT

A communication system and methodology enables a user to receive a message waiting indication in the form of an instant message or a real simple syndication (RSS) formatted message when messages are available for retrieval. The communication system includes a message storage and retrieval system. An instant messaging system having at least one instant messaging client and a RSS system having an RSS client which communicate with the message storage and retrieval system. The instant messaging and RSS system are operable with the message storage and retrieval system to generate a message waiting indication for the user in the form of an instant message or a RSS formatted message.

### BACKGROUND OF THE INVENTION

1. Field of the Invention

The present invention relates generally to providing a message waiting indication for a user and more specifically to providing a message waiting indication for a user in the form of an instant message (IM) or a real simple syndication (RSS) message.

2. Background Art

Since the advent of the internet, communications through the use of an electronic medium have become common place. In particular, electronic mail (email) has virtually replaced traditional means of communicating. Even more recently, an electronic communication and collaboration tool referred to as instant messaging, has experienced substantial usage in facilitating communications.

Instant messaging systems enable users to communicate virtually instantaneously with other users. With the conventional instant messaging systems, each user has a window that is displayed on their respective screens in which messages are entered and received. Composed messages are viewed and received virtually instantaneously. In addition to the significant use of instant messaging systems, most users maintain substantial use of an email system for storage, receipt, and retrieval of email and videomail. Additionally, users continue significant use of other communication systems and retrieval of messages. In particular, real simple syndication (RSS) systems have also experienced substantial adoption by users.

RSS is a file format commonly used by websites and web logs (also known as blogs) to share condensed versions of internet website information. The conventional RSS system includes a RSS server that provides RSS formatted information and an RSS reader. The RSS reader searches internet websites for RSS formatted information. Once the RSS formatted information is found, the RSS reader retrieves and provides the information to the user. RSS readers can be standalone software packages or integrated into other computer applications, such as email clients and web browsers.

Although the foregoing communication systems have experience increased use, they possess several disadvantages. Conventional instant messaging systems and RSS systems are incapable of providing a message waiting indication for a user when messages are available on adjacent messaging systems (i.e., email, voicemail, and videomail systems). For example, when an instant messaging user or RSS system user receives a voicemail on his/her voicemail system, the user is unable to determine, through the use of the instant messaging system or the RSS system that the voicemail has arrived. Additionally, with the conventional instant messaging systems and RSS system, there exists no way of determining, through the use of the instant messaging or RSS system, whether there are any incoming email or videomail messages for the user.

Message waiting indicators sent to or from conventional email (as well as voicemail) systems are limited to brief electronic messages or displays that are sent through the email system, excluding the instant messaging system and RSS system. As commonly known, conventional voicemail and videomail message waiting indicators include flashing lights and modified dial tones that are uncommunicative with the conventional instant messaging system and RSS system. Accordingly, none of the conventional instant messaging systems and RSS systems are adapted to send users a message waiting indication, in the form of an instant message or a RSS formatted message when an email, voicemail, or videomail message is available.

Thus, there exists a need for a communication system capable of sending a user a message waiting indication, in the form of an instant message and/or a RSS formatted message when messages in adjacent messaging systems (i.e., email, voicemail, and videomail systems) are available.

### SUMMARY OF THE INVENTION

The present invention is directed to a communication system and method of providing a message waiting indication for an instant messaging and/or RSS messaging user. The method includes the steps of providing a message storage and retrieval system, an instant messaging system having an instant messaging client, and a presence system. The presence system communicates with the instant messaging system and the message storage and retrieval system. The method also includes the step of determining a mail message status of the message storage and retrieval system through the use of the presence system. The method further includes the step of sending a message waiting indication in the form of an instant message to the instant messaging client, or in the format of a RSS document/message to a RSS reader, wherein the message waiting indication corresponds to the mail message status of the message storage and retrieval system.

The IM notification system includes a message storage and retrieval system and an instant messaging system having at least one instant messaging client. A presence system is also included. The presence system communicates with the instant messaging system and the message storage and retrieval system. The presence system is also adapted to determine a mail message status of the message storage and retrieval system, the presence status of the instant messaging user, and generate the message waiting indication in the form of an instant message for the instant messaging client.

The RSS notification system includes a message storage and retrieval system and a RSS server having at least one RSS client. A web server is capable of creating Extensible Markup Language (XML) documents, and providing user-level security and authentication. The RSS client communicates with the RSS server and the message storage and retrieval system. The RSS server is also adapted to determine a mail message status of the message storage and retrieval system, authenticate the RSS client user, and generate the message waiting indication in the form of a RSS document or message that can be read by the RSS client.

### BRIEF DESCRIPTION OF THE DRAWINGS

These and other features and advantages of the invention will be apparent from the following detailed description and the appended claims, taken in conjunction with the accompanying drawings, in which:

FIGS. 1A and 1B illustrate a communication system adapted to send a message waiting indication according to embodiments of the present invention;

FIG. 2 illustrates a flow diagram of a method for sending a message waiting indication according to an embodiment of the invention; and

FIG. 3 illustrates an exemplary embodiment of a message waiting indication according to an embodiment of the present invention.

### DETAILED DESCRIPTION OF THE PREFERRED EMBODIMENT(S)

By way of example, a preferred system and methodology for implementing the present invention is described below. The provided system and methodology may be adapted, modified or rearranged to best-fit a particular implementation of the present invention.

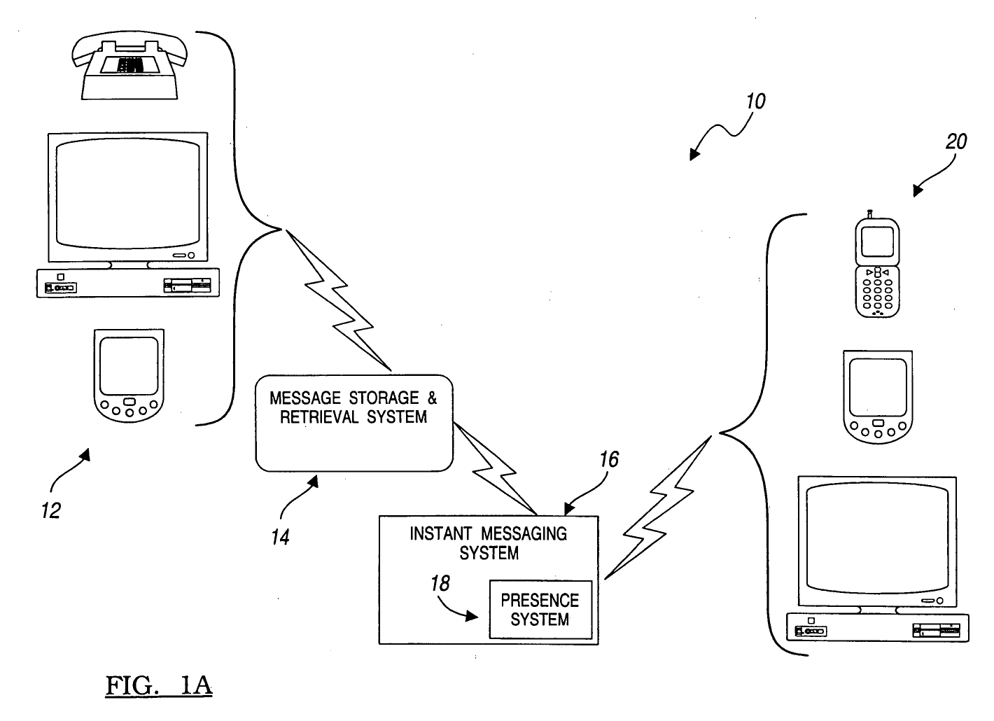

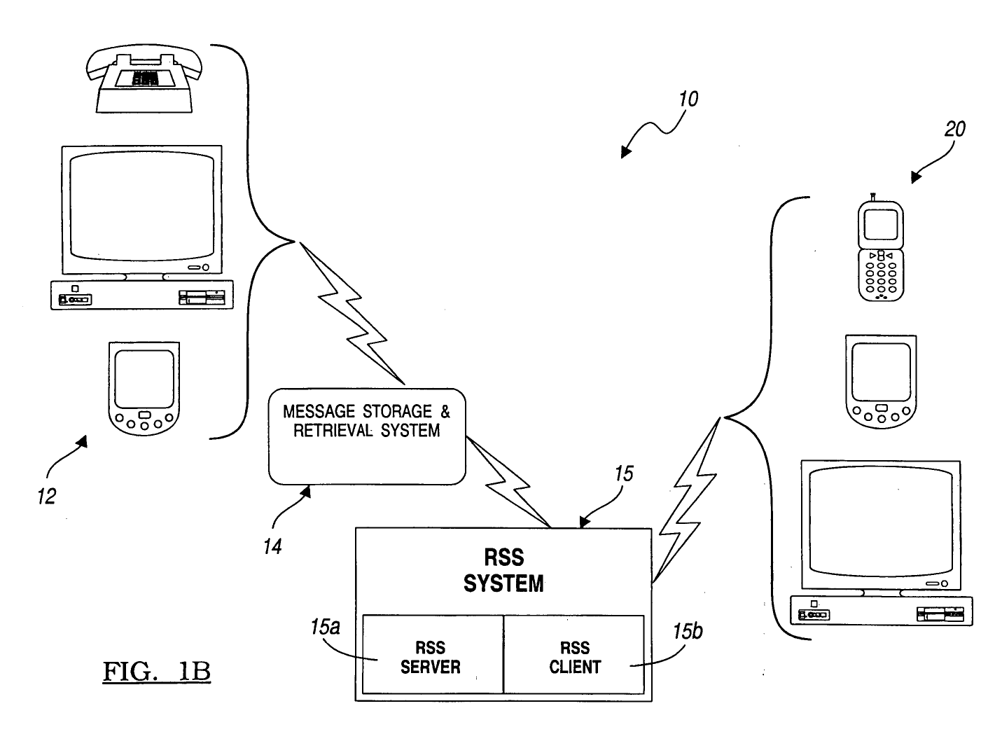

Referring to FIGS. 1A and 1B, a communication system 10 is illustrated. Communication system 10 includes a caller device 12, a message storage and retrieval system 14, a Real Simple Syndication (RSS) system 15, an Instant Messaging (IM) system 16, a presence system 18, and a user device 20. Communication system 10, which may provide telephony and internet services, enables the transfer of voice, video, and data from caller device 12 to user device 20. As such, caller device 12 is capable of initiating and receiving calls and data, and may be a traditional telephone, computer, cellular telephone, or personal digital assistant (PDA).

When a user initiates a call or generates a message on caller device 12 for user device 20, message storage and retrieval system 14 is adapted to store any messages or data to be received by user device 20. Message storage and retrieval system 14 is capable of storing email, voicemail, and/or videomail messages. Accordingly, in one embodiment, message storage and retrieval system 14 may be a unified messaging system having data storage and data processing functionality. Alternatively, message storage and retrieval system 14 may be comprised of separate and distinct systems that store email, voicemail, and/or videomail messages separately. In either embodiment, an instant messaging system 16 communicates with message storage and retrieval system 14 and RSS system 15. (FIG. 1B) Instant messaging system 16 enables user device 20 to send and receive instant messages to/from other instant messaging users. As such, instant messaging system 16 includes an instant messaging client (not shown) that enables communications through the use of instant messaging system 16. The instant messaging client also provides a user interface that is displayed on user device 20.

A presence system 18 is integrated with instant messaging system 16 through the use of a “presence” software that is compatible with instant messaging system 16. Presence system 18 is capable of querying message storage and retrieval system 14 for a mail message status. The mail message status of message storage and retrieval system 14 indicates the presence or absence of a message stored by message storage and retrieval system 14. As recognized by one of ordinary skill in the art, presence system 18 is also capable of determining the “presence status” of an instant messaging user (not shown). The presence status of a user includes, among other attributes, whether the instant messaging user is online or offline. Additionally, in one embodiment, instant messaging system 16, having presence system 18 integrated therein, is capable of generating a message waiting indication in the form of an instant message for the instant messaging client. The generated instant message (i.e., the message waiting indication) is preferably sent upon determination of the mail message status of message storage and retrieval system 14 and presence status of the instant messaging user.

User device 20 is utilized by the instant messaging user to communicate with other instant messaging users through the use of instant messaging system 16. As such, user device 20 may be a PDA, a cellular telephone, or a computer. It is recognized however, that user device 20 is not limited to the embodiments described herein, but may be any device capable of sending and receiving instant messages through the use of an instant messaging system.

Referring specifically to FIG. 1B, an alternative embodiment of communication system 10 is shown that includes RSS system 15. In one embodiment, RSS system 15 is configured to provide user device 20 a message waiting indication using RSS (i.e., real simple syndication) or Extensible Markup Language (XML) files. Accordingly, RSS system 15 includes an RSS server 15a capable of communicating with message storage and retrieval system 14 and user device 20. Furthermore, an RSS client 15b, embodied as a software program, is operable with RSS server 15a. Additionally, RSS system 15, through the use of RSS client 15b, communicates with message storage and retrieval system 14 for retrieval of stored messages (i.e., email, voicemail, and videomail messages). As such, in one embodiment, RSS client 15b periodically searches the message storage and retrieval system 14 for stored messages. When messages are found, RSS client 15b is adapted to send the messages in the form of RSS formatted message to user device 20 for viewing by the user.

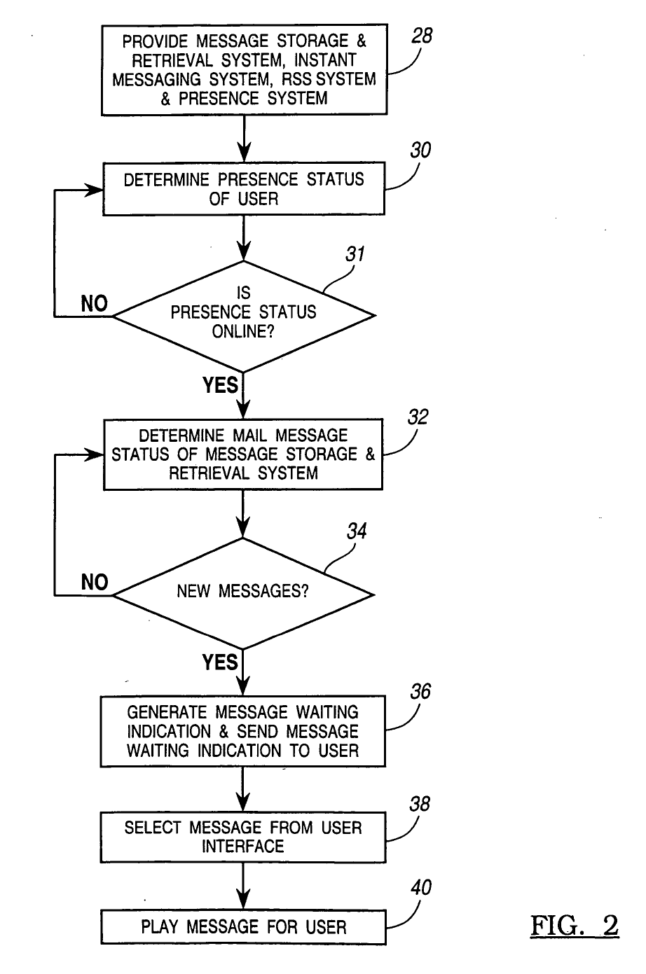

Now referring to FIG. 2, a flow diagram of the methodology for providing a message waiting indication is shown. At a step 28, a message storage and retrieval system, instant messaging system, an RSS system, and a presence system are provided. As discussed above, the presence system communicates with the instant messaging system, and the message storage and retrieval system. Furthermore, the RSS system (FIG. 1B) communicates with the message storage and retrieval system and the user device. The instant messaging system includes at least one instant messaging client that enables communications through the use of the instant messaging system. At a step 30, the presence system determines the presence status of the instant messaging user. At a step 31, the method determines whether or not the presence status is online. If the presence status is not online (e.g., offline), the method returns to step 30. Where the presence status is online, a step 32 occurs. As will be discussed hereinafter, in alternative embodiments, determination of the user's presence status may not be required. Accordingly, in those embodiments steps 30 and 31 may be excluded. For instance, in the embodiment shown in FIG. 1B, the RSS system is operable regardless of the user's presence status.

At a step 32, the mail message status of the message storage and retrieval system is determined through the use of the presence system or alternatively, the RSS system. As discussed above, the mail message status indicates the presence or absence of a new message within message storage and retrieval system 14. Thus, as shown in a step 34, the method determines whether or not any new messages have arrived. If no new messages have arrived, the method returns to step 32. If new messages have arrived, a step 36 occurs. At a step 36, the instant messaging system, having the presence system integrated therein, generates a message waiting indication for the instant messaging client. The message waiting indication is in the form of an instant message and compatible with the instant messaging system and the instant messaging user device. In the case of the embodiment having the RSS system, the RSS system having the RSS client generates the message waiting indication in the form of a RSS formatted message. Accordingly, the user device displays the instant message or RSS formatted message (i.e., the message waiting indication) for viewing by the instant messaging user.

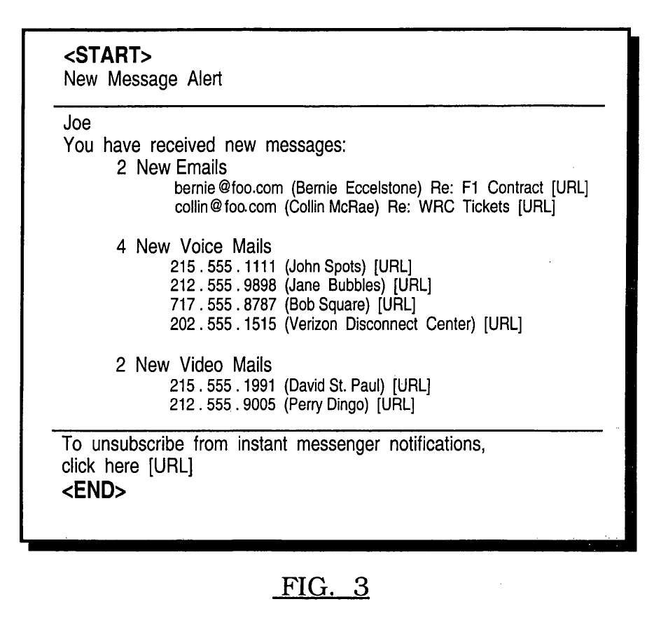

An embodiment of the message waiting indication is shown in FIG. 3. As illustrated, the message waiting indication has an interface that includes a message header, message count, and detailed message information. Specifically, the message waiting indication includes information pertaining to the number of email, voicemail, and videomail messages received, as well as who and where the received messages arrived from. Each message may be embedded within the instant message or RSS formatted message interface as a hyperlink. It is recognized however, that the specific content and form of the instant message or alternatively, the RSS formatted message is dependent upon user and system requirements, but may vary from the illustrated embodiment without departing from the scope of the invention.

Referring back to FIG. 2, at a step 38, the user may, through the use of user device 20, retrieve messages that are stored by message storage and retrieval system 14. The messages may be selected for retrieval by clicking, through the use of a computer mouse or keyboard, directly on the hyperlinked message(s) embedded within the received instant message or RSS formatted message. Additionally, at step 38, the embodiment of the communication system shown in FIG. 1A, the user may retrieve messages (email, voicemail, and videomail) by simply clicking on entries (e.g., user names) within the instant messaging user's “buddy list.” In such an embodiment, the entries having an associated message for the instant messaging user may be a bolded or highlighted hyperlink thereby indicating the available messages. Furthermore, in this embodiment, the determination of the presence status of the instant messaging user is not required. Hence, steps 30 and 31 above may be excluded. In either embodiment (i.e., FIG. 1A or 1B), at a step 40, the selected message is played and/or displayed for the user.

The foregoing system and methodology enables a user to receive a message waiting indication in the form of an instant message or a RSS formatted message when messages are available for retrieval. The present invention allows users to monitor, receive, and respond to messages from adjacent messaging systems (i.e., email, voicemail, and videomail systems) through the use of the instant messaging system and/or the RSS system. Consequently, while embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of providing a message waiting indication for an instant messaging user through the use of an instant messaging system having at least one instant messaging client, a presence system, and a message storage and retrieval system comprising the steps of:
configuring said presence system for communication with said instant messaging system and said message storage and retrieval system wherein said message storage and retrieval system is configured to receive and store email, videomail, and voicemail messages;
determining a mail message status of said message storage and retrieval system through the use of said presence system; and
sending a message waiting indication in the form of an instant message to said instant messaging client, wherein said message waiting indication corresponds to the mail message status of said message storage and retrieval system.

2. A method according to claim 1, further comprising the steps of:
selecting a message within said instant message for retrieval; and
playing the message for receipt by the instant messaging user.

3. A method according to claim 1, wherein the step of determining a mail message status includes determining the presence or absence of an email, voicemail, and videomail message within said message storage and retrieval system.

4. A method according to claim 1, wherein the step of determining a mail message status includes selecting an entry from an instant messaging buddy list that represents a stored message wherein the entry representing the stored message is a bolded or highlighted hyperlink.

5. A method according to claim 1, wherein the step of sending the message waiting indication in the form of an instant message includes sending a message waiting indication having a message count and message header information comprising the number of received email, voicemail, and videomail messages.

6. A communication system for sending a message waiting indication to an instant messaging client, comprising:
a message storage and retrieval system configured to receive, store and forward email, videomail, and voicemail messages;
an instant messaging system having at least one instant messaging client; and
a presence system that communicates with said instant messaging system and said message storage and retrieval system, said presence system being adapted to determine a mail message status of said message storage and retrieval system and, through the use of the instant messaging system, generate the message waiting indication in the form of an instant message for the instant messaging client.

7. A system according to claim 6, wherein said message waiting indication includes a message count and a message header.

8. A system according to claim 6, wherein said mail message status indicates the presence or absence of a message for the instant messaging user within said message storage and retrieval system.

9. A system according to claim 8, wherein said message includes voice mail messages.

10. A system according to claim 8, wherein said message includes video mail messages.

11. A system according to claim 8, wherein said message includes email messages.

12. A system according to claim 6, wherein said instant message includes an interface for the retrieval of messages within said message storage and retrieval system.

13. A system according to claim 12, wherein said interface includes hyperlinks to messages within said message storage and retrieval system.

14. A method of providing a message waiting indication for an instant messaging user through the use of a message storage and retrieval system, an instant messaging system having an instant messaging client, and a presence system comprising the steps of:
configuring said presence system for communication with said instant messaging system and said message storage and retrieval system wherein said message storage and retrieval system is configured to receive and store email, videomail, and voicemail messages;
detecting a presence status of the instant messaging user through the use of said presence system;
determining a mail message status of said message storage and retrieval system through the use of said presence system and;
sending a message waiting indication in the form of an instant message to said instant messaging client when the presence status of the instant messaging user is online, wherein said message waiting indication corresponds to the mail message status of said message storage and retrieval system.

15. A method according to claim 14, wherein said message waiting indication includes a message count and a message header.

16. A method according to claim 14, wherein the step of determining said mail message status includes determining the presence or absence of an email, voicemail, and videomail message within said message storage and retrieval system.

17. A method according to claim 14, wherein the step of sending a message waiting indication in the form of an instant message includes sending an instant message having an interface for the retrieval of messages within said message storage and retrieval system.

18. A method of providing a message waiting indication for a user through the use of a message storage and retrieval system and a real simple syndication (RSS) system having an RSS client system comprising the steps of:
configuring said RSS system for communication with said message storage and retrieval system wherein said message storage and retrieval system is configured to receive and store email, videomail, and voicemail messages;
determining a mail message status of said message storage and retrieval system through the use of said RSS system; and
sending a message waiting indication in the form of an RSS formatted message or document to the user, wherein said message waiting indication corresponds to said mail message status.

19. A method according to claim 18, further comprising the steps of:
selecting a message within said RSS formatted message for retrieval; and
playing the message for receipt by the instant messaging user.

20. A method according to claim 18, wherein the step of determining a mail message status includes determining the presence or absence of an email, voicemail, and videomail message within said message storage and retrieval system.

21. A method according to claim 18, wherein the step of sending a message waiting indication includes a message waiting indication having at least a hyperlink to a message stored by said message storage and retrieval system.

22. A method according to claim 18, wherein the step of sending the message waiting indication in the form of a RSS formatted message or document includes sending a message waiting indication having a message count and message header information.
